(19) United States
(12) Patent Application Publication
(10) Pub. No.: US 2007/0158361 A1
(43) Pub. Date: Jul. 12, 2007

(54) Liquid supply assembly and liquid spray apparatus

(76) Inventor: Yasuhiro Koyama, Tokyo (JP)

Correspondence Address: 3M INNOVATIVE PROPERTIES COMPANY, PO BOX 33427, ST. PAUL, MN, 55133-3427, US

(21) Appl. No.: 11/322,894

(22) Filed: Dec. 30, 2005

(51) Int. Cl. B65D 35/56; A62C 13/62; B05B 9/047; A01G 25/14

(52) U.S. Cl. 222/105; 239/302; 239/323; 239/376

(57) ABSTRACT

A liquid spray apparatus having a liquid supply assembly is disclosed. The assembly has a container and a collapsible liner received within the interior of the container. Sidewalls of the liner have a plurality of annular weak portions. As liquid (e.g. paint) in the liner is dispensed, the sidewalls are folded and collapsed regularly in the longitudinal direction without irregular local transverse deformations. The uniform collapsing of the liner enables stable spraying of the liquid and minimizes the amount of liquid left unsprayed.

### FIELD OF THE INVENTION

The present invention relates to a liquid supply assembly used for mixing and dispensing liquids to be sprayed by liquid spraying devices or spray guns. Also, the present invention relates to a liquid spray apparatus utilizing the liquid supply assembly.

### BACKGROUND OF THE INVENTION

U.S. Pat. No. 6,820,824 B1 discloses a liquid supply assembly, which is used for supplying a mixture of component liquids to be sprayed to a liquid spraying device or spray gun. The liquid supply assembly has an outer container, a removable collapsible liner positioned within the container, and a removable lid located in an opening in the liner. The lid has a connector tube or outlet for a mechanical and fluid connection to an associated adaptor to be connected to the spray gun.

A mixture of component liquids, (e.g., paint) to be sprayed is poured into the removable liner which is received within the outer container and secured by the lid. The lid is then connected to the spray gun via an adaptor. In operation, the liquid is withdrawn from the liner and supplied into the spray gun where it is sprayed with the aid of a compressed air. As the liquid is drained from the liner, the sidewalls of the liner deform and collapse inwardly to reduce its volume. As the liner collapses, it is possible for residual liquid to remain in the liner depending on the extent to which the liner creases and folds upon itself as it collapses. Incomplete draining of the liner is undesirable as it leads to wasting of liquid spray material.

### SUMMARY OF THE INVENTION

To overcome this disadvantage, a liquid supply assembly having collapsible liner that has a plurality of annular weak portions is disclosed herein. Each of the weak portions extends continuously peripherally so that the sidewalls of the liner are folded in a direction of a central axis of the liner as the amount of liquid remaining in the liner decreases. The uniform collapsing of the liner enables stable spraying of the liquid and minimizes the amount of liquid left unsprayed.

In an embodiment, the present disclosure relates to a liquid supply assembly, comprising, in combination: (1) a reservoir having side walls and a bottom wall defining an interior surface; (2) a collapsible liner for receiving a liquid to be sprayed, the liner having sidewalls connected by a base at one end and defining an opening at the opposite end, the liner being positioned within the interior of the reservoir; and (3) a lid positioned in an opening of the liner to close the opening, the lid further having a connector tube through which the liquid is dispensed from the liner. The sidewalls of the collapsible liner have a plurality of annular weak portions, each of the weak portions extending continuously peripherally so that the sidewalls are folded in a direction of a central axis of the liner as liquid is dispensed from the liner.

In a further embodiment, the present disclosure relates to a liquid spraying apparatus, comprising, in combination: (1) a reservoir having sidewalls and a bottom wall defining an interior surface; (2) a collapsible liner for receiving a liquid to be sprayed, the liner having sidewalls connected by a base at one end and defining an opening at the opposite end, the liner being positioned within the interior of the reservoir; (3) a lid positioned in an opening of the liner to close the opening, the lid further having a connector tube through which the liquid is dispensed from the liner; (4) a spray device for spraying the liquid from the liner; and (5) an adaptor for mechanical and fluid connection of the connector tube to an associated portion of the spray device so that the liquid is dispensed from the liner into the spray device. The sidewalls of the collapsible liner have a plurality of annular weak portions, the weak portions extending continuously peripherally so that the sidewalls are folded in a direction of a central axis of the liner as the amount of liquid remaining in the liner decreases.

### BRIEF DESCRIPTION OF THE DRAWINGS

FIG. 1 is a perspective view of an exemplary liquid spray apparatus;

FIG. 2 is an exploded view of an exemplary liquid supply assembly;

FIG. 3 is a cross sectional view of the liner shown in FIG. 1;

FIG. 4 is a perspective view of the liner of FIG. 3, shown in a collapsed position;

FIG. 5 is a graph showing test results for various liner configurations;

FIG. 6A is a perspective view of an exemplary liner;

FIG. 6B is an enlarged partial cross sectional view of the liner of FIG. 6A;

FIG. 6C is an enlarged partial cross sectional view of the liner of FIG. 6A;

FIG. 7 is a cross sectional view of an exemplary liner.

### DETAILED DESCRIPTION OF THE PREFERRED EMBODIMENTS

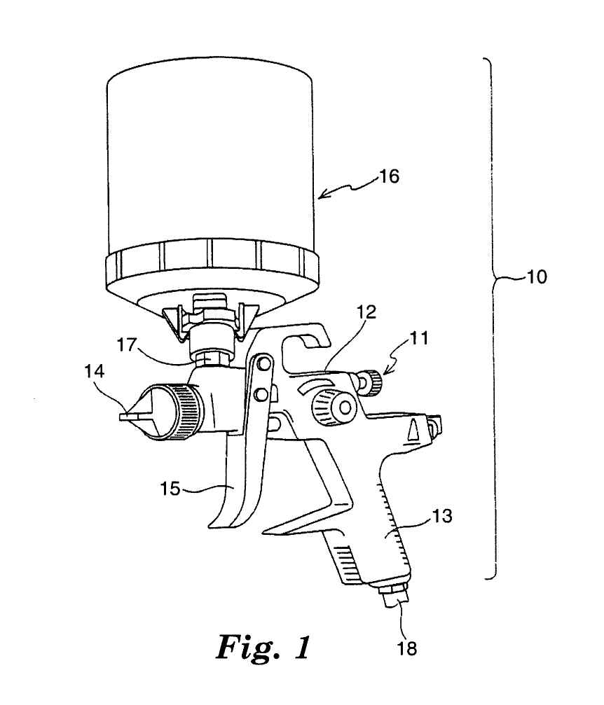

With reference to the drawings, several embodiments of the liquid supply assembly and the liquid spraying apparatus will be described in detail below. FIG. 1 illustrates a liquid spraying apparatus generally indicated by reference numeral 10. The apparatus 10 has a conventional paint spray gun generally indicated by reference 11. The spray gun 11 has a body 12, a handle 13 which extends downward from the rear end of the body 12, and a spray nozzle 14 at the front end of the body. The spray gun 11 is manually operated by a trigger 15, which is pivotally mounted on the sides of the spray gun 11. A liquid supply assembly, generally indicated by reference numeral 16, for supplying a mixture of component liquids, e.g., paint, to be sprayed by the spray gun 11, is connected at an inlet 17 on the top of the body 12 and communicates with an internal passageway (not visible) for compressed air, which extends through the spray gun 11 from a connector 18 at the lower end of the handle 13 to the nozzle 14 and entrains and atomizes paint which is being delivered from the liquid supply assembly 16. The paint is then discharged through the nozzle 14 with the compressed air. Such a liquid supply assembly is generally described in U.S. Pat. No. 6,820,824 B1 (Joseph, et al.), incorporated by reference herein in its entirety.

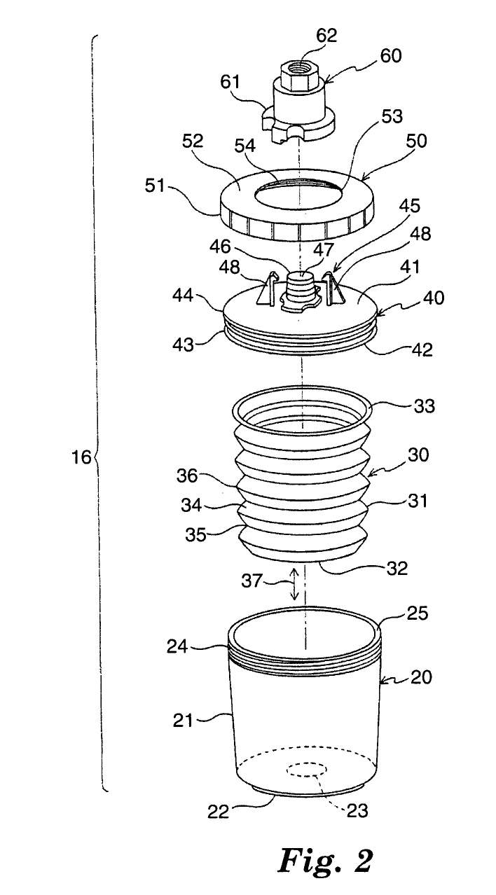

As illustrated in FIG. 2, an exemplary liquid supply assembly 16 has an open container (reservoir), generally indicated by reference numeral 20, which in an embodiment, is in the shape of conical frustum. The container 20 has sidewalls 21 and a bottom wall 22 extending across the bottom end of the sidewalls 21 and having an air aperture 23 which connects between the interior and exterior of the container 20. An outer peripheral surface of the sidewalls 21 has external threads 24 in the vicinity of the top end for connection with a collar described below. The container 20 may be made of any suitable rigid or flexible material and may be opaque or transparent. In an embodiment, the container is made of transparent polypropylene.

A collapsible cup-like liner, generally indicated by reference numeral 30, has an outermost configuration corresponding to the interior of the container 20 so that it can be close fitted within the interior of the container 20. Specifically, the liner 30 has sidewalls 31 and a bottom wall 32 extending across the bottom end of the sidewalls 31. In an embodiment, the liner 31 has an outwardly projecting top flange or rim 33 along the top edge of the sidewalls 31 so that, when the liner 30 is received within the container 20, the rim 33 sits on the top end 25 of the container 20. The liner 30 may be made of any suitable flexible material and may be opaque or transparent. In exemplary embodiments, the liner 30 may be made of transparent polyethylene or polypropylene.

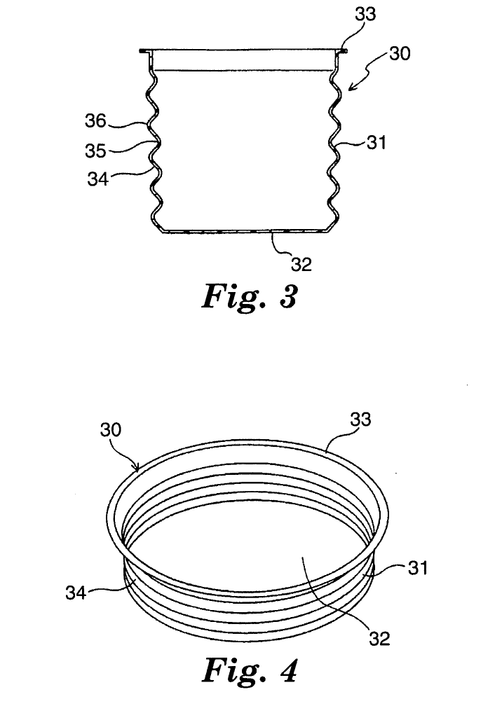

In the embodiments shown in FIGS. 2 and 3, the sidewalls 31, which are substantially in the form of an accordion or concertina, have a plurality of annular pleats 34 with inner and outer weak portions 35 and 36 each extending continuously and peripherally formed at regular intervals in the longitudinal direction 37 so that the side wall 31 is folded up easily and regularly in the direction by the vacuum pressure generated within an interior of the liner 30 upon spraying of the paint (see FIG. 4). In order to improve the folding ability while keeping an unsupported, standing ability of the liner 30, the liner 30 in one embodiment is made of flexible material such as low-density polyethylene (LDPE) having a tensile strength of about 8.8-17.6 N/cm. In an embodiment, the thickness of the sidewall is reduced to about 20-150 μm. In a further embodiment, the thickness of the sidewall is reduced to 50-100 μm.

In an embodiment, the thickness of the bottom wall 32 of the liner 30 is reduced to about 20-150 μm. In a further embodiment, the thickness of the bottom wall 32 of the liner 30 is reduced to 50-100 μm. This causes the bottom wall 32 to be deformed inwardly with less resistance as the paint is consumed, which reduces the residual amount of paint unsprayed.

A lid generally indicated by reference numeral 40, has a circular plate 41 and a cylindrical axial projection 42 extending downwardly from the peripheral edge of the circular plate 41, each of which having a sufficient thickness for retaining its configuration. The cylindrical projection 42 has one or more annular ridges 43 provided around its outer surface and projecting outwardly so that the axial projection 42 is close fitted within the top opening of the liner 30. The circular plate 41 has an annular flange 44 extending outwardly and along the peripheral edge of the circular plate so that, when the cylindrical projection 42 is fitted within the opening of the liner 30, the flange 44 sits on the top rim 33 of the liner 30. In addition, the top surface of the circular plate 41 bears a first adapter generally indicated by reference numeral 45. The adapter 45 has a tube-like connector 46 defining an opening, or outlet, 47 through which, when the lid 40 is connected at the top opening of the liner 30, the liquid within the liner 30 may be supplied through the outlet 47. The adapter 45 also has a pair of hooks 48 positioned adjacent to and on opposite sides of the connector 46. Details of an exemplary adapter 45 are described in U.S. Pat. No. 6,588,681 B2 (Rothrum, et al.), which is incorporated by reference in its entirety.

An annular sealing ring or collar generally indicated by reference numeral 50, which is made polymeric material such as polypropylene and polycarbonate or metal material such as aluminum, has a cylindrical portion 51 extending axially and a top portion 52 extending inwardly to a certain extent from the top end of the cylindrical portion 51 to define a central opening 53 at the center of the collar 50. The cylindrical portion 51 has internal threads 54 capable of engaging with the external threads 24 of the container 20.

A second adapter generally indicated by reference numeral 60, which in an embodiment is a machined, cylindrical metal component made of aluminum or stainless steel, has engaging portions 61 in its outer surface and internal threads 62 in its inner surface. Details of the second adapter 60 are also described in U.S. Pat. No. 6,588,681 B2 (Rothrum, et al.).

It should be appreciated that the various components of the liquid supply assembly shown in FIG. 2 are exemplary, and, as may be appreciated by one skilled in the art, alternate configurations are possible. For example, the threads 24 on the outer container, threads 54 on the collar 50, and annular ridges 43 on the lid may be replaced by other fastening means, the collar 50 may be eliminated in lieu of additional structure on the lid, adaptors 45 and 60 may be differently configured, and so on. The embodiments shown herein are exemplary in nature and not intended to limit the scope of the invention.

In operation, the liner 30 is pushed within the interior of the container 20 and the rim 33 of the liner 30 is placed on the top end 25 of the container 20. Paint or another liquid (not shown) is poured into the liner 30. Then, the lid 40 is placed on the combination of the container 20 and the liner 30 as the axial projection 42 of the lid 40 is forced in the top opening of the liner 30 and the peripheral flange 44 of the lid 40 is placed on the peripheral top end 33 of the liner 30. Next, the collar 50 is placed on the lid 40 and then rotated so that the internal threads 54 of the collar 50 are engaged with the associated external threads 24 of the container 20 to hold the lid 40 in position. With the collar in place, the peripheral flange 44 of the lid 40 firmly contacts the opposing peripheral rim 33 of the liner 30 to form a continuous seal therebetween. Then, the second adapter 60 is fluidly and mechanically connected with the first adapter 45.

The liquid supply assembly 16, once assembled, is attached to the spray gun 11 by inverting the spray gun 11 from its normal operating position to fluidly and mechanically connect the adapter 60 of the assembly 16 to the inlet 17 of the spray gun 11. Residual air in the liner may be removed prior to the painting operation. The spray gun 11 with the liquid supply assembly 16 attached is returned to its normal position as shown in FIG. 1 and is ready for use in the usual way. In the spray operation, when the trigger 15 is pulled, the paint in the liner 30 is delivered into the passage within the body 12 of the spray gun 11, entrained by compressed air, and then sprayed from the nozzle 14 toward the substrate to be painted.

As the paint is consumed and the amount of paint remaining within the liner 30 is decreased, the inverted liner 30 deforms and folds regularly in the longitudinal direction 37. As the liner collapses, the accordion-like sidewalls bend at weak portions 35 and 36 and prevent the sidewalls from locally collapsing inwardly (see FIG. 4). The weak portions 35, 36 of the sidewalls allow the liner to collapse with minimum resistance. As a result, a constant amount of paint is sprayed with a lower pressure, and the amount of residual unsprayed paint is minimized.

The liners and liquid supply assemblies disclosed herein are also suitable for use in pressurized liquid spray systems. A pressurized liquid spraying apparatus is described in copending application Ser. No. 11/053085 (attorney docket number 60464US002), incorporated by reference herein in its entirety. This disclosure describes pressurized liquid spray systems utilizing liquid supply assemblies having containers pressurized above about 69.0 kPa (10 psi).

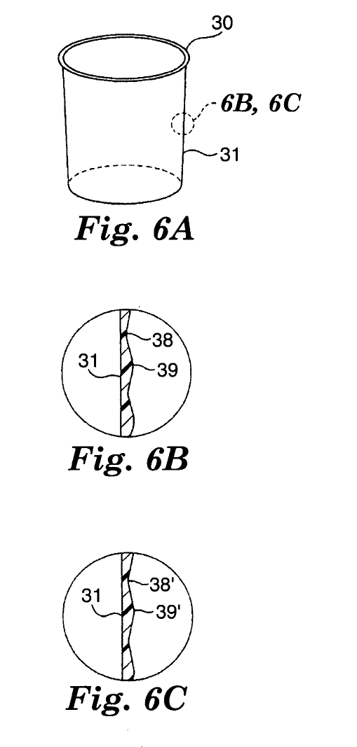

In further embodiments, the sidewalls of the liner may take on alternate configurations such as corrugated tube. Alternatively, as shown in FIGS. 6A to 6C, the side walls 31 may have annular weak portions including thin portions (curved thin portions 38, angled thin portions 38′) and thick portions (curved thick portions 39, angled thick portions 39′) alternately at regular intervals in the longitudinal direction. Also, as shown in FIG. 7, the inner diameter of the liner 31 may be changed stepwise to form weak portions 35 and 36. Each of the above variations causes the liner to be folded regularly in the longitudinal direction without causing any local transverse collapse in the side walls, which facilitates stable spraying of the liquid and minimizes the residual liquid left unsprayed.

In further embodiments, the liner may be made of a multi-layered film of two polymer layers made, for example, of polyethylene and nylon, and a metal layer made of aluminum, for example, deposited on either of the polymer layers and sandwiched therebetween. In this embodiment, the thickness of the sidewall may be thinned to about 20-150μm, or 50-100 μm, in a further embodiment. An exemplary multi-layered film has a tensile strength of about 8.8-17.6 N/cm. This arrangement provides an enhanced gas barrier feature and air-tightness to the liner.

### EXAMPLES

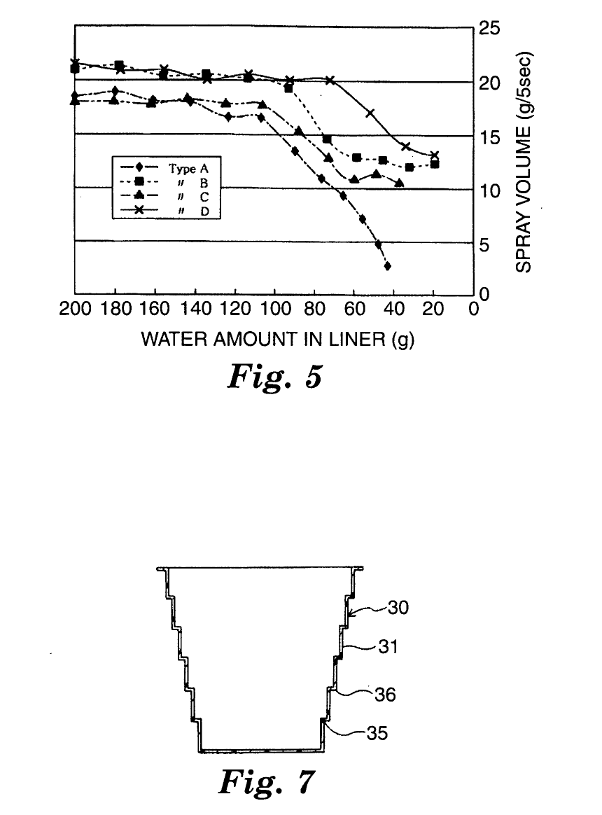

To evaluate the spraying characteristics of the liquid supply assembly according to the present invention, tests were conducted using four liners, Types A-D, made of polyethylene. Types A and B were conventional, conical frustum cup-like liners without pleats, having respective thicknesses of about 200-300 μm and about 6011 m. Types C and D were accordion-like liners with pleats, having respective thicknesses, about 200-300 μm and about 60 μm. The pressure of compressed air was 2.5 kg/cm². Each liner was filled with water of 200 g. The result is shown in the graph of FIG. 5.

As can be seen from the graph, the sprayed volume per five seconds from the device using the conventional liners Types A and B decreased abruptly at the residual amount of about 100 g. In contrast, the device using the liners Types C and D according to the present invention showed the abrupt decrease in the sprayed volume at the residual amount of about 100 g and 70 g, respectively. Thus, using the liner of the present invention ensures more stable spraying of the liquid. The graph also shows that the amounts of unsprayed water for the conventional liners Types A and B were about 42 g and 38 g, respectively, and those for the liners Types C and D were about 20 g. Thus, the amount of unsprayed liquid is reduced by the use of liners according to the present invention.

Additional tests were conducted to evaluate i) Evenness of sprayed pattern, ii) Ability of unsupported standing of the liner (self-supporting), iii) Solvent resistance, and iv) Ability of restoration for liners with different wall thicknesses, less than 50 μm, 50-100 μm and more than 100 μm. Evenness of sprayed pattern was evaluated by visual inspection of the pattern sprayed on the substrate. Ability of unsupported standing was evaluated by putting a certain amount of water, 300 g, into the liners and then judging visually whether the liners retained the original shapes. Solvent resistance was evaluated by dipping the liners in xylene for one hour and then measuring a swelling rate (SR) defined by the following formula:
SR=100 ta/tb
SR: Swelling Rate (%)
ta: Thickness after dipping
tb: Thickness before dipping

The ability of restoration was evaluated by visual inspection of whether collapsed liners restored their original configurations.

Tests result is indicated in the following table.

Thickness of liner

| | 50 μm< | 50-100 μm | 100 μm> |
|---|---|---|---|
| Evenness | Excellent | Good | Fair |
| Standing | Not Good | Good | Good |
| Solvent resistance | Over 106% | 101-105% | 101-105% |
| Restoration | Not Good | Good | Good |

Although a particular embodiment according to the present invention has been described, it can be modified in different ways and the scope of the present invention should only be limited by the scope of the claims.

What is claimed is:

1. A liquid supply assembly, comprising, in combination:
a reservoir having side walls and a bottom wall defining an interior surface;
a collapsible liner for receiving a liquid to be sprayed, the liner having sidewalls connected by a base at one end and defining an opening at the opposite end, the liner being positioned within the interior of the reservoir; and
a lid positioned in an opening of the liner to close the opening, the lid further having a connector tube through which the liquid is dispensed from the liner;
wherein the sidewalls of the collapsible liner have a plurality of annular weak portions, each of the weak portions extending continuously peripherally so that the sidewalls are folded in a direction of a central axis of the liner as liquid is dispensed from the liner.

2. The liquid supply assembly of claim 1, wherein the sidewalls of the liner have a concertina shape.

3. The liquid supply assembly of claim 1, wherein the sidewalls of the liner are in the shape of corrugated tube.

4. The liquid supply assembly of claim 1, wherein a wall of the reservoir contains an air aperture.

5. The liquid supply assembly of claim 1, wherein a diameter of the liner is decreased stepwise in the axial direction.

6. A liquid spraying apparatus, comprising in combination:
a reservoir having sidewalls and a bottom wall defining an interior surface;
a collapsible liner for receiving a liquid to be sprayed, the liner having sidewalls connected by a base at one end and defining an opening at the opposite end, the liner being positioned within the interior of the reservoir;
a lid positioned in an opening of the liner to close the opening, the lid further having a connector tube through which the liquid is dispensed from the liner;
a spray device for spraying the liquid from the liner; and
an adaptor for mechanical and fluid connection of the connector tube to an associated portion of the spray device so that the liquid is dispensed from the liner into the spray device;
wherein the sidewalls of the collapsible liner have a plurality of annular weak portions, the weak portions extending continuously peripherally so that the sidewalls are folded in a direction of a central axis of the liner as the amount of liquid remaining in the liner decreases.

7. The liquid spraying apparatus of claim 6, wherein the sidewalls of the liner have a concertina shape.

8. The liquid spraying apparatus of claim 6, wherein the sidewalls of the liner are in the shape of corrugated tube.

9. The liquid spraying apparatus of claim 6, wherein a wall of the reservoir contains an air aperture.

10. The liquid spraying apparatus of claim 6, wherein a diameter of the liner is decreased stepwise in the axial direction.

11. The liquid spraying apparatus of claim 6, wherein the spray apparatus is a pressurized spray apparatus wherein the reservoir is pressurized above about 69.0 kPa (10 psi).
